(19) United States
(12) Patent Application Publication
(10) Pub. No.: US 2015/0121338 A1
(43) Pub. Date: Apr. 30, 2015

(54) PROVIDING CONTEXT IN A SWF FILE PROCESSOR

(71) Applicant: Pieter SENSTER, London (GB)

(72) Inventor: Pieter SENSTER, London (GB)

(21) Appl. No.: 13/169,895

(22) Filed: Jun. 27, 2011

(51) Int. Cl. G06F 9/44; G06F 3/048

(52) U.S. Cl. CPC G06F 8/70
USPC 717/120; 715/719

(57) ABSTRACT

A SWF processing tool, a computer-readable storage medium, and method are provided that give accurate feedback about processing of a SWF file. Discrepancies between the development environment that is used to create a SWF file and features of the SWF processing tool are notified by a warning system that provides context for warning messages. A parser creates a set of interconnected nodes that have edges between a root node, nodes for at least one scene, nodes for control tags and nodes for display object tags, in which the display object nodes are not directly connected by an edge to a scene node. The tags are processed such that when a warning condition is determined for a tag, a representative path of edges connecting the node associated with the tag to the root node is retrieved. A combination of the representative path and a warning message can be displayed.

### BACKGROUND OF THE INVENTION

1. Technical Field

Apparatus, method and computer-readable storage medium storing program code for processing SWF files and providing context for warning messages.

2. Background

A Flash Integrated Development Environment (Flash IDE) produces as an output a SWF file. Some Web browsers can have a Flash plug-in component installed in order to handle SWF files and show graphic images or Movie Clips. This Flash plug-in is not available for all Web browsers. Also, Web technologies are evolving, such as HTML5 and Scalable Vector Graphics (SVG), which enable showing of graphic images or Movie Clips directly by the Web browser, without the need for installation of a plug-in.

Developers use the Flash IDE, for example, to develop advertisement creatives. A developer that uses the Flash IDE may prefer to have graphic images and Movie Clips in the format of an SWF file be rendered in Web browsers that do not support, or have not had installed, the Flash plug-in.

Developer tools are available or may be made for performing processing of SWF files. Examples of SWF processing tools include SWF debuggers, SWF compilers, SWF decompilers, as well as alternative playback engines to the flash plug-in. A useful feature of SWF processing tools would be a capability of provide messages so that a developer can be notified of potential problems such as compatibility problems or other possible differences between how a SWF tool handles SWF files and features that the Flash IDE may have used in generating the SWF file.

For example, the inventor has made a cross-compiler that can provide warning messages in order to inform the developer of differences. In some cases, the cross-compiler consolidates multiple SWF tags into a single intermediate tag. In other cases, not all SWF tag properties are supported. The cross-compiler reports information such as differences or unsupported properties as warning messages.

However, the SWF file can include definition tags that provide information that is useful for processing by the Flash plug-in, but are unknown to a developer. With a few exceptions, the concept of a definition does not exist in the development environment for creating SWF files. Also, the SWF file can include other tags that provide additional information in support of definition tags. The definition and support tags may be located at arbitrary positions in the SWF file. For example, a developer may have placed an object in frame 3 using the Flash IDE. The resulting SWF file includes a definition for the object, and the location in the file of the definition for the object may be in frame 1. In this example, the developer may not be able to fully comprehend the intent of a warning message that is generated for a definition tag in frame 1, as the developer is only aware that they had intended to place an object in frame 3. Provided a complex SWF file, a developer would have extreme difficulty determining what object or objects the definition tag, which the warning is for, correspond to.

A warning message generated, for example, for a definition tag that is encountered during processing of the SWF file may not provide sufficient information to a developer. The warning may have been because the SWF tag contained an unsupported property. However, because the developer would not be aware of definitions, and the location of definitions in the SWF file may not correlate with objects where they are placed in frames, the warning message may not be sufficient to help the developer understand the reason for the warning message.

In the particular case of MovieClip and Button definitions, referred to as symbols, the Flash IDE does make a developer aware of a definition. For example, in the Flash IDE, names are given to symbol definitions, which can be used in obtaining the symbol definition from a symbol library and placed as an instance on the stage. However, such names of symbols are not exported to the SWF file. Instead, a SWF file only indicates that there exists a symbol, having an id number.

### BRIEF SUMMARY

An aspect of the invention is a SWF processing tool, non-transitory computer-readable storage medium storing a program and computer-implemented method, in which the computer includes at least one processing unit, a memory storing structured data, and a display device, including providing to the processing unit the structured data that defines a timeline for displaying an animation or scene, the structured data includes a tag for one or more scenes, one or more control tags for placing display objects in the one or more scenes, and at least one display object tag that is under the control of a control tag. The at least one processing unit performing steps of analyzing the structured data, to create a set of interconnected nodes, including creation of a root node, creating a node for a scene tag and adding an edge that connects the scene node to the root node, creating a node for a control tag and adding an edge that connects the control node to the scene node, creating a warning context node for a display object tag and adding an edge that connects the warning context node to the control node, thereby creating a set of interconnected nodes, in which the warning context nodes are not directly connected by an edge to a scene node. The tags contained in the structured data are processed including selecting a representative path of edges connecting the node associated with the tag to the root node is retrieved, generating a display for the representative path and a warning related to the warning condition, and displaying by the display device a representation of the path and the warning.

Provided a set of interconnected nodes, a context for warning messages can be presented in the form of a representative path. Accurate feedback about processing of structured data is provided.

In a further aspect, the structured data is a SWF file.

Discrepancies between the development environment that is used to create a SWF file and features of the SWF processing tool are notified by providing context for warning messages.

In a further aspect the representative path is a shortest path of edges connecting the node associated with the tag to the root node.

Provided a shortest path of edges, a context for warning messages is notified in a manner that gives only information that is necessary to express a context.

A further aspect includes a step of selecting a path that includes names in control tags, and a step of displaying the selected path along with the warning.

Provided selection of a path that includes names in control tags, paths that are unreachable from a root node can be notified with the warning.

These and other aspects are described in detail with respect to the drawings.

### BRIEF DESCRIPTION OF THE DRAWINGS

The accompanying drawings constitute part of this specification. In the drawings,

FIG. 1 is a block diagram of an environment for processing SWF tags.

FIG. 2 is a chart showing example actions based on SWF tag type.

FIGS. 3A, 3B, 3C and 3D are flow diagrams for creating a structure that establishes context for warning messages and generation of warning messages.

FIG. 4 is a chart showing examples of printed messages for nodes.

FIG. 5 illustrates an example warning graph.

FIG. 6 illustrates a second example warning graph.

FIG. 7A shows an example output for displaying grouped warning messages and FIG. 7B shows an example where a grouped warning message is expanded to display associated context.

FIG. 8 is a conceptual drawing of an example SWF file.

FIG. 9 illustrates a third example warning graph for the SWF file of FIG. 8.

FIG. 10 is a block diagram of a development environment that generates code for Web technologies.

FIG. 11 is a flow diagram for a cross-compiler that produces an intermediate format.

FIG. 12 is a block diagram for an example server computer.

### DETAILED DESCRIPTION

SWF files produced as an output of the Flash IDE can be processed by the Flash player, or may be processed by other programs that can render graphic images and MovieClips using a SWF file. For example, alternative SWF players may be available for playing animations specified by SWF files. In addition, a SWF debugger may be used to detect errors due to information in the SWF file. A SWF compiler may be used to compile a SWF file into an alternative format. A SWF decompiler may be used to restore an original Flash file that was used to generate the SWF file.

It would be useful to developers if the various tools that may process SWF files, such as SWF player, a SWF debugger, SWF compiler, and SWF decompiler could produce warning messages based on information contained in the SWF file itself. However, since the SWF file includes tags that the developer is not aware of, and in locations in the SWF file that are unrelated to frames where a developer has placed objects, reporting meaningful warning messages becomes difficult. Furthermore, processes such as the SWF player, a SWF debugger, or SWF compiler are limited to information provided in the SWF file itself, leading to a deficiency in information available to a developer in determining a reason for a warning message.

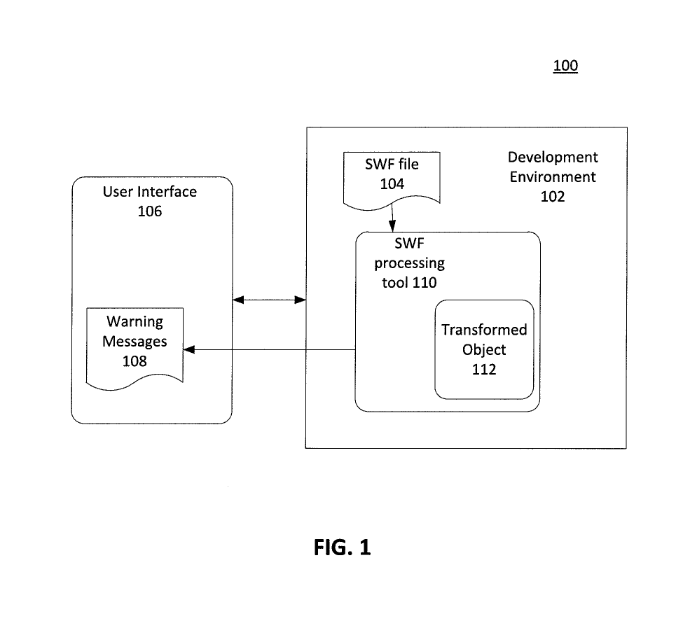

FIG. 1 is a block diagram of a development environment that may be used by a developer that has used the Flash IDE to create a SWF file. The development environment 102 provides the user with one or more SWF processing tools 110 that can be used to process the SWF file 104 into some form of a transformed object 112. A user interface 106 may be provided to enable the developer to interact with the development environment 102, as well as receive feedback in the form of, for example, warning messages 108.

A disclosed solution to this discrepancy in information involved in processing by the Flash IDE and the resulting SWF file is to create a formal structure of the SWF file that reflects relationships between definitions for items and when items are used. For example, the SWF file uses a concept of shape definition that is not a concept within the Flash IDE. In accordance with the organization of a SWF file, the shape definition itself is not directly referenced in a frame of a Movie Clip, but instead is placed in a frame by a PlaceObject tag. The original shape definition may be located in another position in the SWF file. Because PlaceObject tags may occur in SWF files within different frames than the location in the SWF file where a shape definition is made, a developer may be unable to determine a reason for the warning. As a type of formal structure, that can aid in providing information as to a reason for a warning message, a warning graph of the SWF file can be created that relates the SWF tags. The warning graph can be a directed acyclic graph.

A SWF file defines a timeline consisting of one or more frames, control tags for placing and removing display objects on the timeline, definitions for display objects, and other data that is useful for rendering a desired display. Using conventional SWF tags, in a simplest form, a SWF file may define a timeline that includes a single frame or scene. The single frame can contain a single control tag, referred to as a PlaceObject tag. The role of the PlaceObject tag may be to place an object defined by a definition tag, such as DefineShape, on the stage.

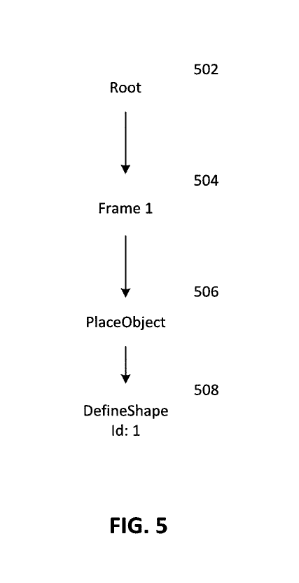

In general, a warning graph for a SWF file can contain three types of nodes: a special root node, one or more frame nodes, and tag nodes. FIG. 5 shows an example warning graph created from a SWF file for a timeline having a single frame with one shape. The root node 502 of the warning graph represents the main timeline, serving as the main reference point for the developer. Every frame on the main timeline is represented by a frame node, such as frame node 504. The root node references all frame nodes.

A frame node can only reference a certain class of SWF tags that are logically placed in that frame from the developer's point of view. The main class of nodes referenced by a frame node is a class of nodes associated with control tags, for example nodes representing PlaceObject tags, such as PlaceObject 506. PlaceObject tags place an object defined by a definition tag on the screen. Subsequently, in a SWF file, the PlaceObject tag is always within the frame in which the developer placed the object on the stage. PlaceObject tags can refer to definition tags, such as DefineShape 508. In addition, there can be other tags that provide information for definition tags. Definition tags and other tags that provide information for definition tags can be for several occurrences of objects to be placed in frames. As can be seen, for example, in the directed graph of FIG. 5, nodes associated with definition tags and other related tags are not directly referenced by a frame node.

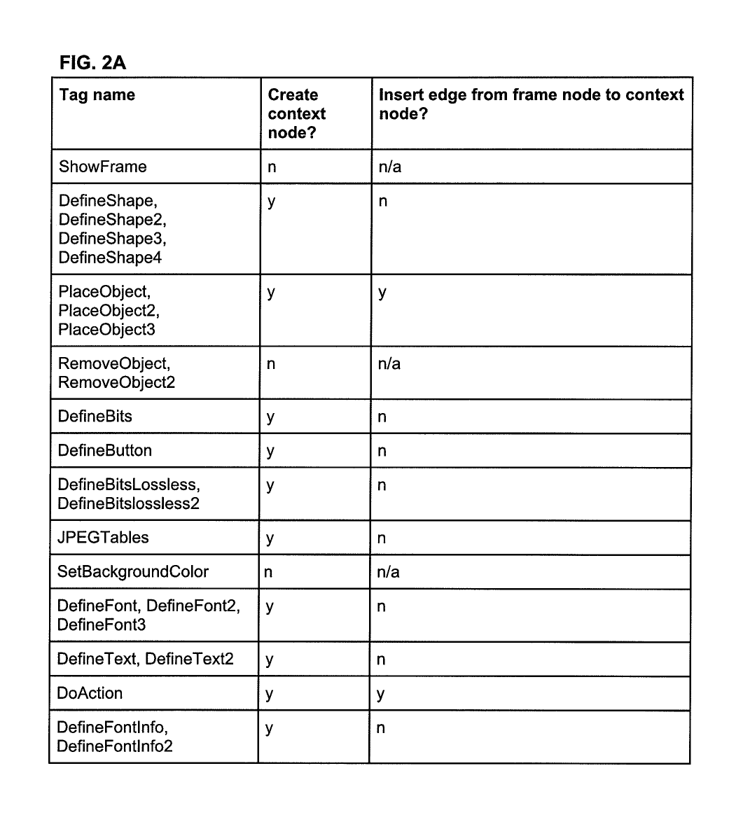

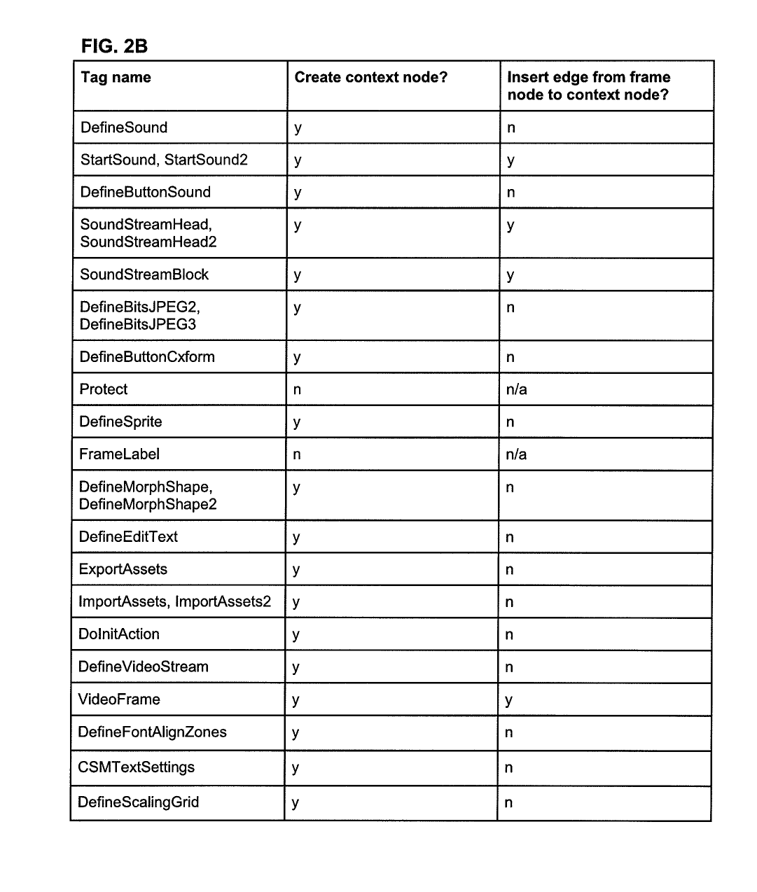

A warning graph provides context information for warning messages related to objects to be placed during an animation. In an example aspect, context nodes in a warning graph are represented by objects, referred to as WarningContextNode objects. In an example aspect, an object, SwfListener (for the main timeline), and an object, DefineSpriteTransformer (for Movie Clips), create WarningContextNode objects using a WarningManager. FIGS. 2A and 2B show a chart providing an example of how a version of SWF tags may be handled during the graph generation process. The list of SWF tags is provided as an example, and is not intended to limit the scope of the invention. Types of control tags and definition tags may differ from this list, but would be handled in a similar manner.

As can be seen in FIGS. 2A and 2B, in the column “Create context node?” all tags except the ShowFrame and RemoveObject tags involve the creation of a context node. Instead, the ShowFrame involves creation of a frame node. The RemoveObject node does not involve creation of a node, as the removal of an item does not provide any useful context for the developer.

In the column “Insert edge from frame node to context node?” a “Y” indicates that an edge is inserted from the current frame node to the context node. These context nodes are nodes said to be “logically placed within the frame from the user's point of view.” The current frame node is the parent of the SWF tag. When the current frame node is a tag on the main timeline, the current frame node is referenced by the root node. When the current frame node is within a DefineSprite tag, the current frame node is the frame node referenced by the context node of the DefineSprite tag.

When a warning is raised in a SWF processing tool 110, the warning will have a reference to the tag that raised it in the warning graph. Provided a completed graph, the context of a warning can be determined by calculating the paths from the root node to the tag node to which the warning points. A shortest path can be selected as a path representative of the context of the warning message. Provided the selected path, a warning generated for the, for example, DefineShape tag 508 in the case shown in FIG. 5 may be displayed as:

Main timeline>Frame 1>{warning message}

In selecting a path from the root node to a context node that has a warning, such as the shortest path, not every node on the path is useful for the user. For example, a complete path may be:

Root>Frame 2>PlaceObject (id: 2, name “child”)>DefineSprite

(id: 2)>Frame 2>PlaceObject>DefineShape (id: 1)

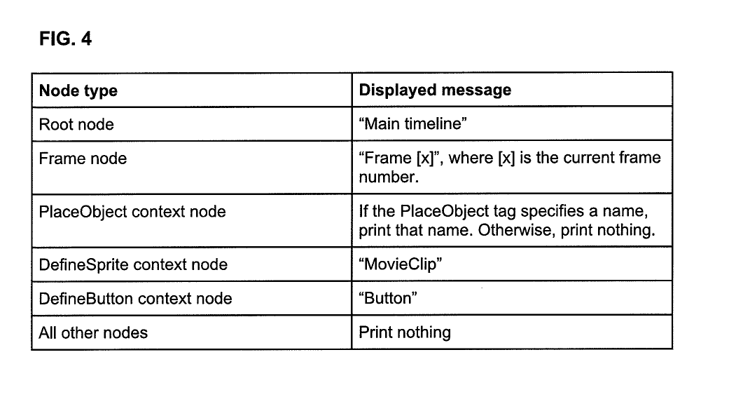

This complete path describes several nodes that might be unfamiliar to the user. The user may not know about definitions and PlaceObject tags. Instead of displaying a complete path, FIG. 4 provides a chart that describes for each type of node (“Node type”) that might occur in the warning graph, a message (“displayed message”) that will be displayed. Node types that are not listed in the chart are not displayed as part of a path.

Using the list of displayed messages shown in FIG. 4, the above complete path will instead be displayed as:

Main timeline>Frame 2>“child”>MovieClip>Frame 2

An exception is the ExportAssets tag, in which labeled edges are inserted in the graph. The edge labels are displayed verbatim. For example, when a SWF file contains an ExportAssets tag that exports definition x with name ‘header’, the following context will be displayed for any warnings reported in the definition x:

Main timeline>“header”

Displaying context in this manner ensures that names assigned to definitions using ExportAssets tag will always be the shortest path from the root node to the definition node. This is desirable because it is also the name that makes it easiest for the user to find the definition.

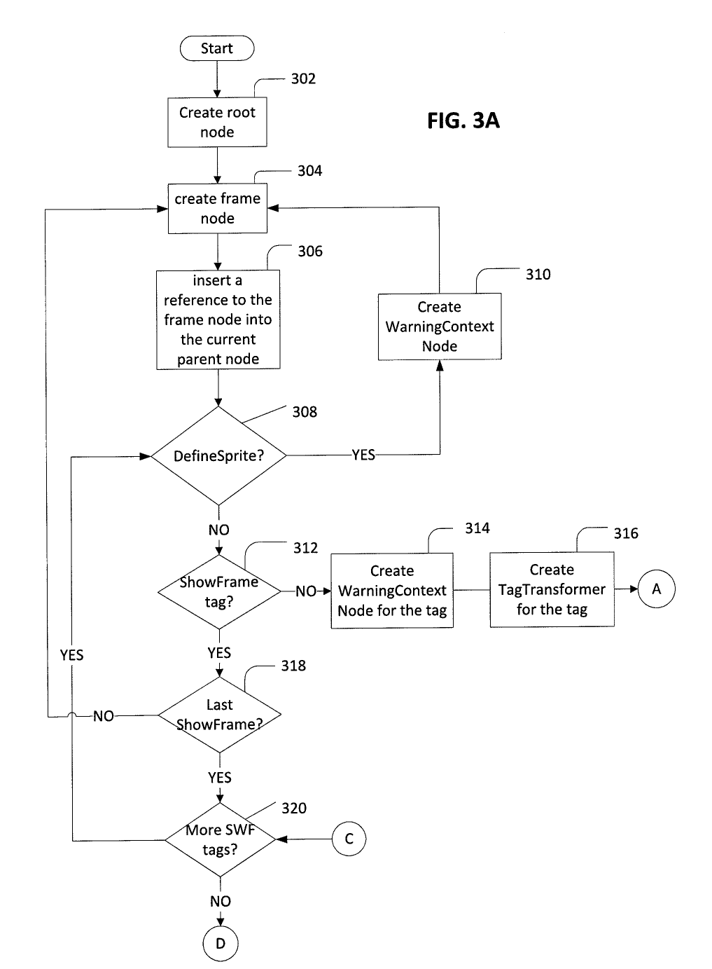

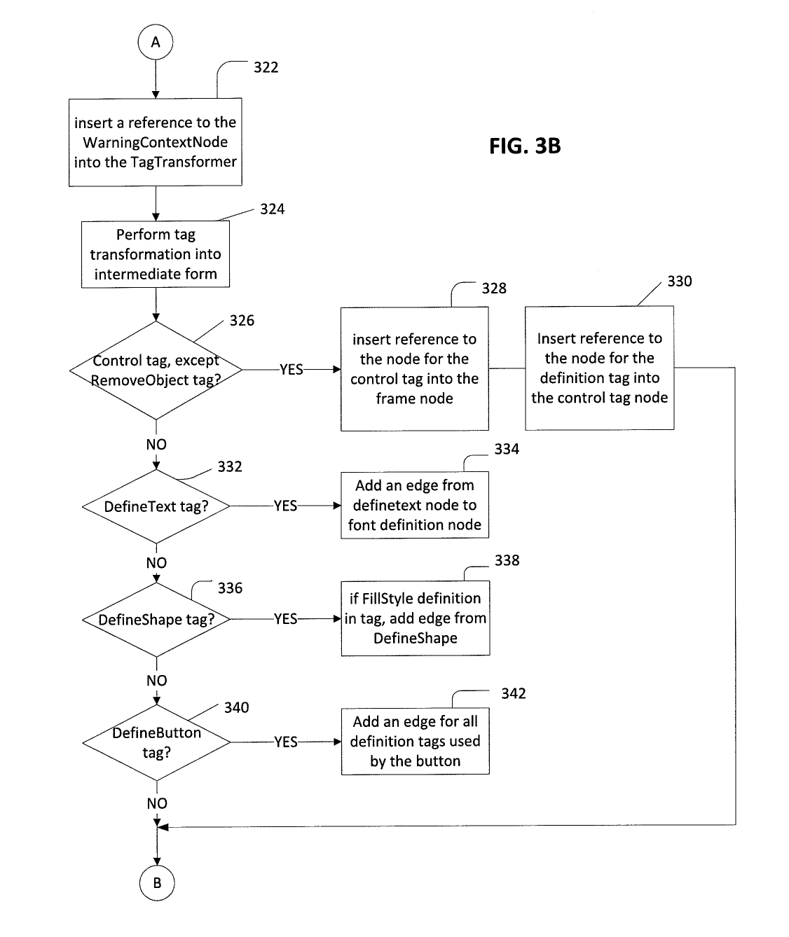

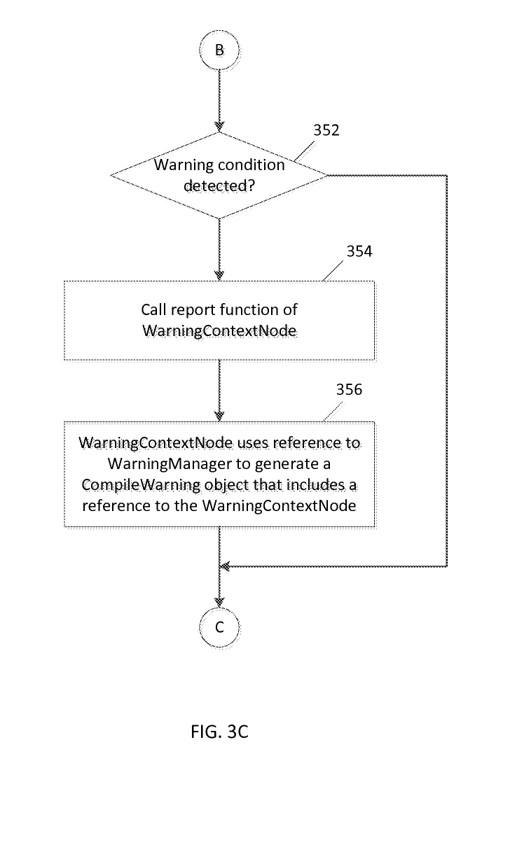

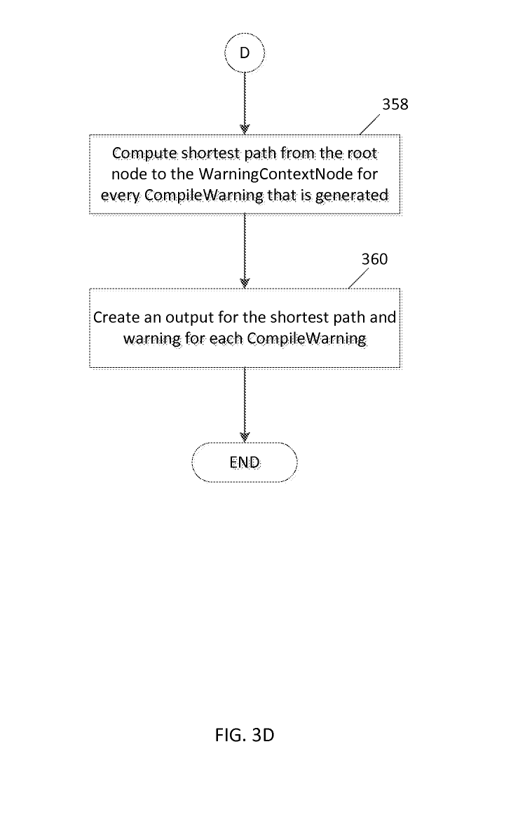

FIGS. 3A, 3B, 3C, 3D show a flow diagram for a process of creating a directed acyclic graph representation of a SWF file. In an example embodiment, an object referred to as WarningManager maintains the directed graph. In step 302, a root node is created for the main timeline. An initial frame node is created at step 304, and at step 306, a reference to the frame node is inserted into the root node, in order to create an edge in the directed graph. At step 308, a check is made to determine if a SWF tag encountered in the SWF file is a definition for a Movie Clip, referred to as a DefineSprite tag. A DefineSprite tag is treated similar to a root node, in the sense that it may reference frame nodes, in which case processing loops back to step 304.

At step 312, a check is made to determine if a SWF tag encountered in the SWF file is a ShowFrame tag. A ShowFrame tag indicates an end of a previous frame, as well as a beginning of a next frame. When a ShowFrame tag is encountered, a check is made at step 318 to determine if the ShowFrame tag is a last ShowFrame tag within a Movie Clip. It the ShowFrame tag is not the last ShowFrame tag, processing loops back to step 304 to create a frame node.

If at step 312, it is determined that the SWF tag is not a ShowFrame tag, other tags encountered in the SWF file are processed for purposes of establishing warning messages associated with SWF tags and transforming SWF tags using tag transformer objects. Other tags that may be encountered in a SWF file may be control tags that provide additional information for a definition tag. For example, the DefineFontInfo tag provides additional information about an earlier defined font and the DefineButtonCxForm provides the color transformation for a button symbol. Such control tags that provide additional information for a definition tag can be referred to as helper tags. Both definition tags and helper tags are not directly referenced by a frame node.

At step 314, a WarningContextNode object is created with respect to a control, definition, or helper SWF tag. The WarningContextNode object can contain several methods. A report function takes as an input a description of the warning and passes the warning description on to the WarningManager. Among methods for constructing a warning graph, include an addReference method, that can take as input the character id of the definition to which an edge should be added. For example, the addReference method can be called to instruct the WarningContextNode to add a reference to a node. The WarningContextNode will then use the WarningManager to look up the WarningContextNode of node, and add an edge in the graph between the two WarningContextNodes.

At step 316, a tag transformer, referred to as a TagTransformer object, is created for the tag. A TagTransformer object contains a method, referred to as TransformTag, which recognizes properties of a tag, and transforms a SWF tag into an object in the intermediate representation. In an example aspect, TagTransformer objects transform SWF tags into an intermediate structure, such as JSON objects. A warning graph that connects WarningContextNodes is constructed while SWF tags are being transformed.

In FIG. 3B, at step 322, a reference to the WarningContextNode is inserted into a TagTransformer object. At step 324, the TagTransformer object performs tag transformation operation on the tag. At step 326, a check is made to determine if a tag is a control tag. RemoveObject tags are not included in the warning graph, as they would not provide useful information to a developer. In a SWF file, only control tags are directly referenced by frames. An example of a control tag is a SWF PlaceObject tag. In the case that a tag is a control tag, at step 328, a reference to the node for the control tag is inserted into the corresponding frame node. At step 330, a node for a definition tag is assigned an edge to the associated control tag by inserting a reference to the node for the definition tag into the control tag. A single definition tag in a SWF file can be associated with several control tags.

In certain tags, the associated TagTransformer may extract a reference to a definition for attributes related to the tag. For example, in the case of a DefineText tag, the TagTransformer may extract a reference to a font definition, identified by a character id. As another example, a DefineShape tag may have an associated FillStyle definition. At step 332, in the case of a DefineText tag, at step 334, an edge is added from a WarningContextNode for a DefineText tag to a font definition node, if one exists. At step 336, in the case of a DefineShape tag, at step 338, an edge is added from a WarningContextNode for a DefineShape tag to a FillStyle definition node, if one exists. At step 340, in the case of a DefineButton tag, at step 342, an edge is added for all nodes of definition tags associated with the button. A TagTransformer may encounter a condition that would raise a warning. FIG. 3C is a flow diagram for steps that can occur when a warning condition is detected. At step 322, a determination is made as to whether a warning condition has been detected. In the case that a warning condition has been detected, at step 324, the reporting function of the WarningContextNode that is referenced by the TagTransformer is called. At step 326, the WarningContextNode uses its reference to the WarningManager to generate a CompileWarning object. The Compile Warning object includes a reference to the WarningContextNode, which is connected within the directed graph. The WarningManager reports a CompileWarning object that includes the reference to the WarningContextNode.

FIG. 3D is a flow diagram for a process of generating warning messages using the warning graph. For warnings that are raised, there may be several different paths in the directed graph between the WarningContextNode that reports the warning and the root node. For example, there may be a warning raised by a shape definition that is placed twice on the stage in a Movie Clip. In another example, if this Movie Clip is placed three times on the main timeline, there may be at least six paths to the warning. In most cases, it may be sufficient to output just the shortest path to the tag that raised the warning. In FIG. 3D, in step 328, the shortest path from the root node to the WarningContextNode is computed for every CompileWarning that is generated. In step 330, an output for the shortest path and warning is created for each CompileWarning.

As an alternative to selecting a shortest path to the WarningContextNode, the most descriptive path can be selected. A descriptive path can be measured by the number of names on the path. For example, a node may have two paths to it: one with PlaceObject nodes without names, and one with PlaceObject nodes with names. The path having names could be selected as being more descriptive, even if it is a longer path than the other path.

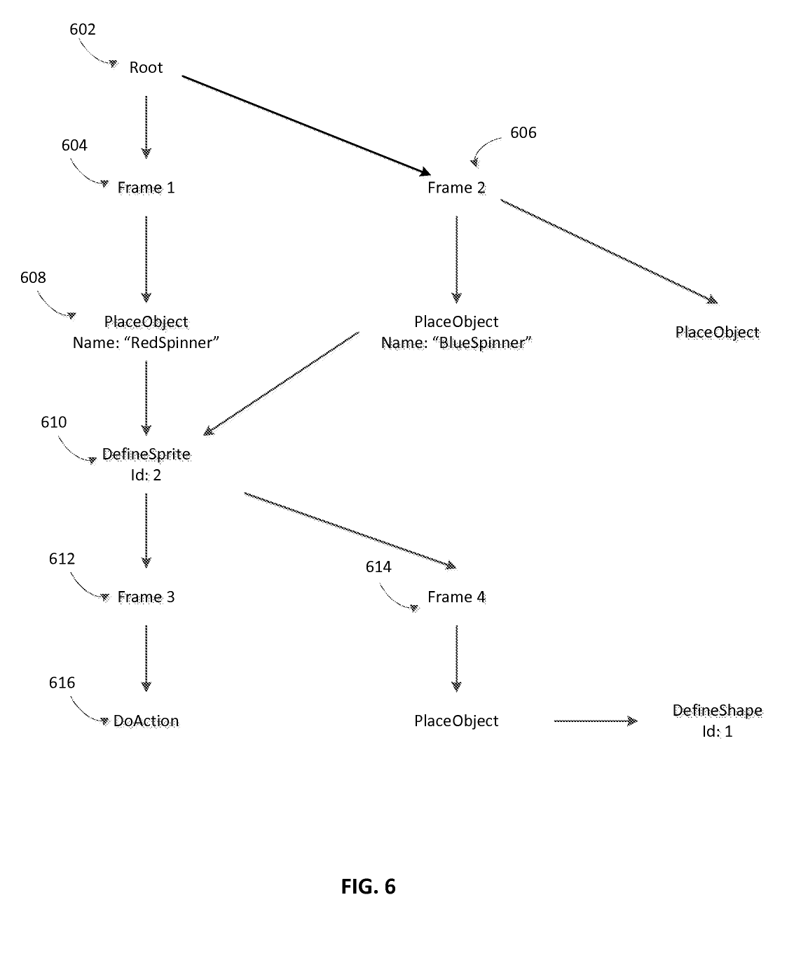

FIG. 6 shows a directed graph for an example in which a main timeline 602 includes a Movie Clip (DefineSprite, id: 2) 610. Similar to a root node for a main timeline, a DefineSprite node (representing the MovieClip) directly references one or more frame nodes. The frame nodes may reference nodes for control tags that make up the sprite. FIG. 6 shows the DefineSprite node 610 within Frame 1 (604) and Frame 2 (606) of the main timeline 602. The DefineSprite node 610 also references its own Frame 1 (612) and Frame 2 (614). The Frame 1 (612) of the DefineSprite node 610 references a node for DoAction 616. The Frame 1 (604) of the main timeline 602 references a node for PlaceObject tag, having a name: “RedSpinner” 608.

When a warning is created for the DoAction tag, the following warning may be generated based on the shortest path from the root node to the node for DoAction tag:

Main timeline>Frame 1>“RedSpinner”>Frame 1: {warning message}

In an example embodiment, a single warning may occur many times in the same file, leading easily to over a hundred warnings for a SWF file. An aspect is to group warnings by warning type and/or warning message. By grouping warnings having the same message (but different context), the number of displayed warnings can be reduced by an order of magnitude. All contexts in which a grouped warning occurred can be displayed.

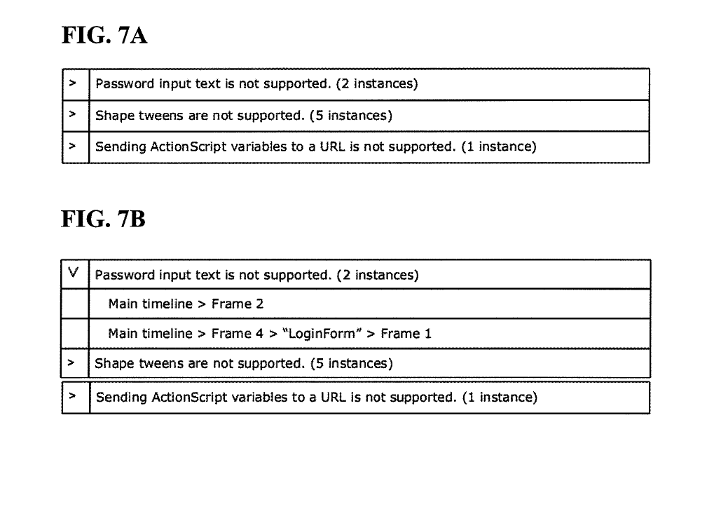

FIG. 7A shows an example initial list of warnings that may be displayed. FIG. 7B shows an example of where one of the listed warnings is expanded to list all contexts in which the grouped warning occurred.

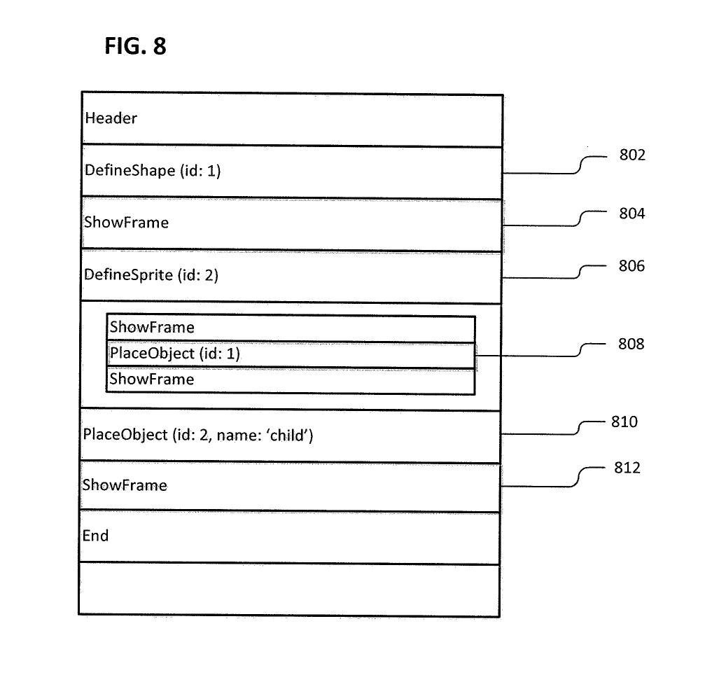

FIG. 8 is a conceptual SWF file for an example for a main timeline having two frames, as defined by tags down to the first ShowFrame tag 802, and tags between the first ShowFrame tag 802 and the last ShowFrame tag 812. The first frame on the main timeline contains a DefineShape tag 804 only. This DefineShape tag 804, being a definition tag, does not render something to the screen.

The second frame of the main timeline contains a DefineSprite tag 806 and a PlaceObject tag 810 that places the DefineSprite definition on the screen. The DefineSprite tag 806 is a nested MovieClip, having a definition with its own timeline with control tags.

The nested MovieClip contains two frames. The first frame is empty whereas the second frame places the DefineShape definition with id 1 on the screen by way of PlaceObject (id: 1) 808.

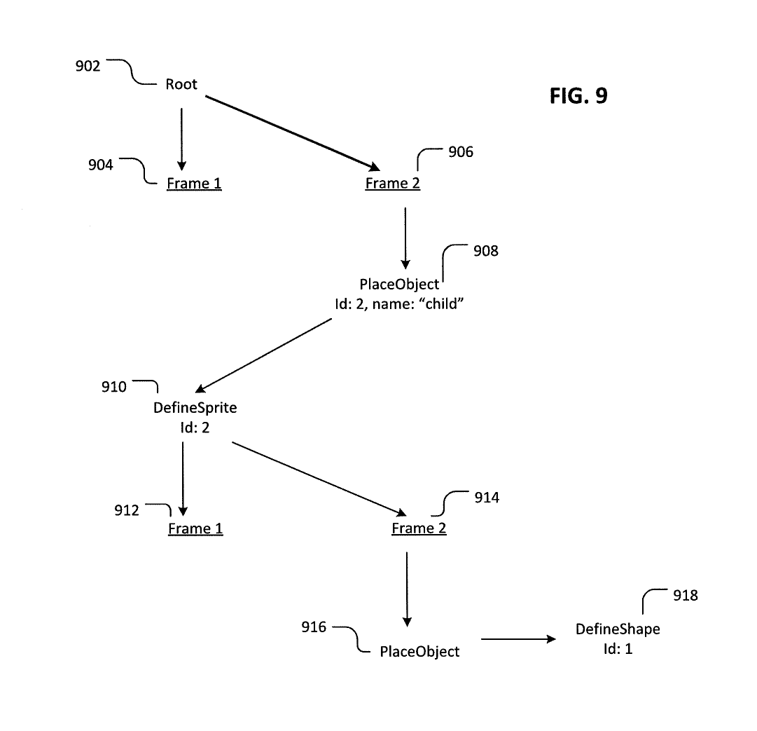

FIG. 9 illustrates an example warning graph that can be generated from the SWF file of FIG. 8. Steps involved in creating the example warning graph are shown in FIGS. 3A and 3B. In this example, the DefineShape tag 802 may have an associated warning message. For example, a developer may have intended that a red rectangle object be placed on the stage in Frame 2 (914) of a MovieClip 910. However, it may be the case that the SWF processing tool 110 can only handle black rectangles, and does not support a color property for rectangles.

In the example of FIGS. 8 and 9, processing performed by a SWF processing tool 110, begins by reading the header portion of the SWF file. At step 302, a root node 902 is created for the main timeline. At step 304, a frame node 904 is created, and at step 306, an edge is created between the root node 902 and the frame node 904. A DefineShape tag 802 is read by the SWF processing tool 110, in which case a WarningContextNode 918 is created for the DefineShape tag 802 at step 314.

Reading ShowFrame tag 804 constitutes an end of a first frame in the main timeline. ShowFrame tag 804 also constitutes the beginning of a second frame, as determined at step 312. At step 304, a new frame node 906 is created. The main timeline contains a Movie Clip, defined by the DefineSprite tag 806, read at step 308. At step 310, a WarningContextNode 910 is created for the DefineSprite tag 806. At step 304, a frame node 912 is created, and at step 306, an edge is inserted between the WarningContextNode 910 and frame node 912. Within the Movie Clip, a ShowFrame tag constitutes both an end of a first frame of the Movie Clip and the beginning of another frame. At step 304, a new frame node 914 is created, and at step 306, an edge is inserted from the WarningContextNode 910 of the DefineSprite tag 806 to the new frame node 914. Within the second frame of the Movie Clip is a PlaceObject tag 916. PlaceObject tag 916 is a control tag, in which case a WarningContextNode 916 is created at step 314, and at step 328, an edge from the current frame node 914 to the WarningContextNode 916 is inserted. The PlaceObject tag 808 places an object having id: 1 on the screen. The object having id: 1 is DefineShape definition tag 802. Thus, at step 330, an edge from the PlaceObject WarningContextNode 916 to the WarningContextNode for DefineShape 918 is inserted. The next ShowFrame tag in the Movie Clip is the last ShowFrame tag, as determined in step 318.

At step 320, a check is made as to whether there are more SWF tags in the SWF file. Another control tag, PlaceObject tag 810 is read, and at step 314, a WarningContextNode 908 is created, and at step 328, an edge from the current frame node 906 to the PlaceObject WarningContextNode 908 is created. The PlaceObject tag places an object with id: 2, name: ‘child’ on the screen. The object having id: 2 is the DefineSprite tag 806. Thus, at step 330, an edge from the PlaceObject WarningContextNode 908 to the WarningContextNode 910 is inserted.

A last ShowFrame tag 812 is encountered in the SWF file of FIG. 8. At step 318, determination that the ShowFrame tag 812 is the last ShowFrame tag is performed. At this point, the warning graph is completed.

This warning graph includes a path from the root node 902 to the DefineShape WarningContextNode 918 that gives context for warnings associated with the DefineShape tag. Thus, even though the DefineShape tag 802 was placed in the first frame of the main timeline in the SWF file, a context that is used for warnings, based on this graph and terms shown in FIG. 4, can be provided as:

Main timeline>Frame 2>“child”>MovieClip>Frame 2

The developer is thus informed that a reason for a warning message is that a DefineShape tag in the SWF file does not support a property of the rectangle object placed in Frame 2 of the Movie Clip.

There may be cases where nodes in the graph do not have a connected path to the root node. Such nodes may be unreachable due to factors, including that the SWF processing tool 110 does not support the particular tag that would have resulted in the addition of an edge in the graph.

Nodes that are unreachable from the root node may be handled by outputting a warning without any context. In an alternative aspect, a path to the node that provides the best context may be output. For example, a best context may be the path from a Movie Clip or Button with a name. A cross-compiler for a SWF file is a type of SWF processing tool 110. In addition to parsing a SWF file to create an intermediate representation, the cross-compiler can create a directed acyclic graph for the SWF file. Creation of the directed acyclic graph representation for tags in a SWF file and generation of context for warning messages using the directed graph, gives the developer accurate feedback about the compilation process. Types of accurate feedback include the context of a feature of a graphic image or Movie Clip that caused a compiler warning. The disclosed context for warning messages bridges discrepancies between concepts that are presented in the SWF file and concepts in the IDE that were used during constructing the SWF file.

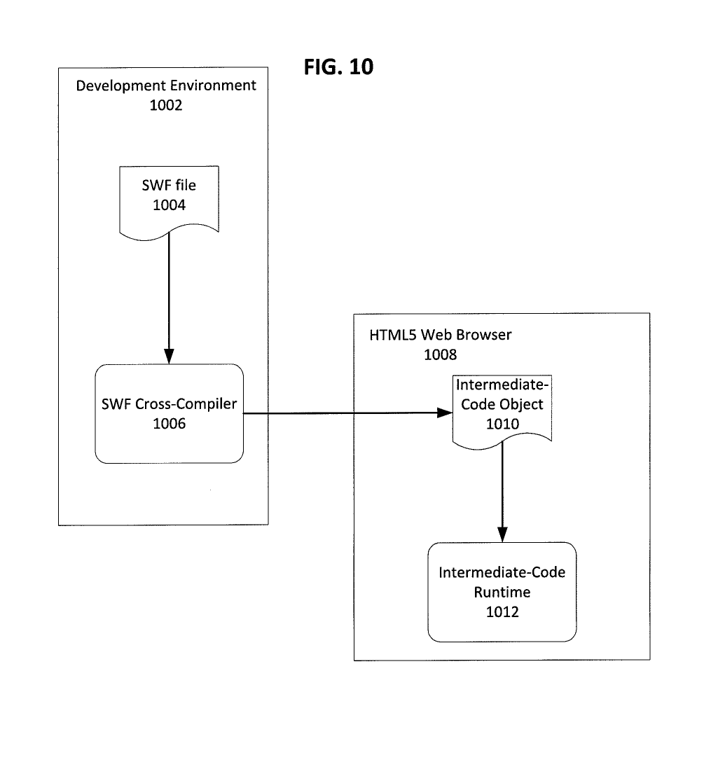

FIG. 10 is a block diagram of processes for rendering a SWF file, for a Web browser that can handle Web technology such as SVG and HTML5. A Web browser 1008 should be capable of rendering HTML5 having SVG tags. A development environment 1002 includes the cross-compiler 1006, which converts the SWF file 1004 into an intermediate structure 1010. The intermediate structure 1010 is a data structure that organizes data produced by the Cross-Compiler 1006. The intermediate structure 1010 can be a JSON object (JavaScript Object Notation), or XML document. An Intermediate-Code Runtime 1012 can be a JavaScript® program that generates SVG nodes from data in the intermediate structure 1010 and performs play back operation for a frame or animation by the Web browser 1008.

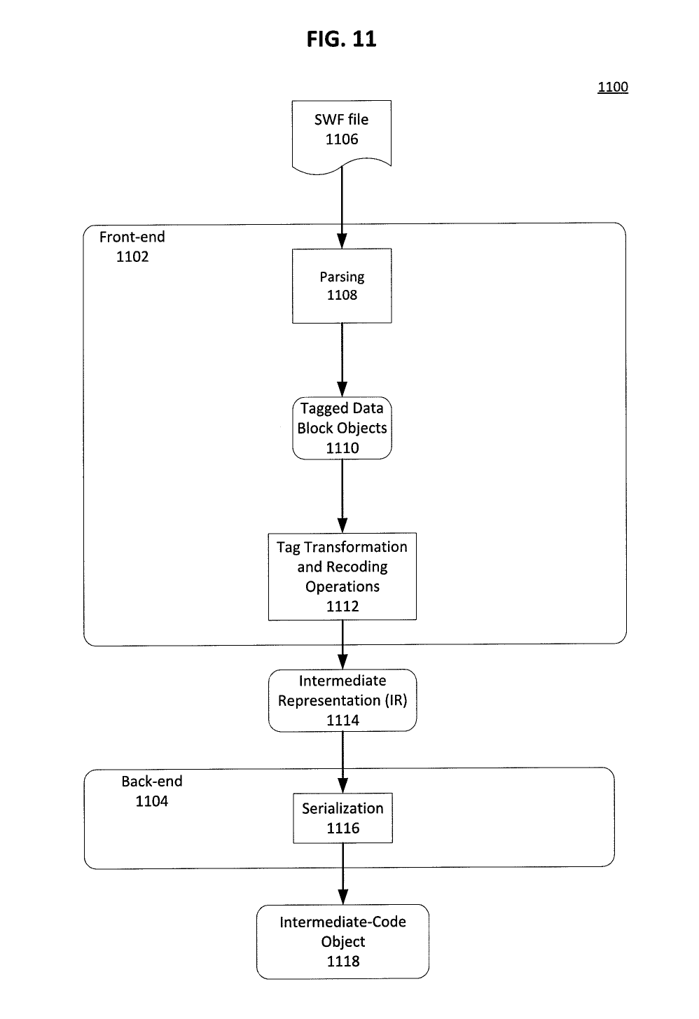

A flowchart of a process performed by the Cross-Compiler 1006 is shown in FIG. 11. The Cross-Compiler 1006 has a front end 1102 for producing an Intermediate-Code intermediate representation and a back end 1104 for serialization to produce the Intermediate-Code object. In the front end 1102, the Cross-Compiler parses, at step 1108, the SWF file 1106. The SWF file 1106 is in binary format. The parser section of the Cross-Compiler analyzes the binary data in the SWF file 1106 and identifies the tagged data blocks. Types of tagged data blocks are defined in the SWF specification. Then, for each data block, the parser creates a SWF tag. One of the data blocks contains header information. The Cross-Compiler next generates, at step 1110, Intermediate-Code tagged data block objects that represent the SWF tags in a hierarchical structure. At step 1112, tags are transformed to their counterpart in the intermediate representation (Intermediate-Code IR), at step 1114.

In addition to SWF tags that have been transformed into JSON key:value pairs, the Cross-Compiler 1006 performs transformations to produce elements that are compatible with HTML5. The Cross-Compiler 1006 produces a DefineImage object. The Tag transformation step 1114 also includes processes including Image transformation, video/audio recoding and transcoding, support checking and vector graphics conversion. The Cross-Compiler 1006 determines whether or not there is support for each SWF tag encountered, and if a tag is not supported, the Cross-Compiler will provide a warning message. The messages aid a developer in determining which features will not be provided in browsers that do not include the Adobe® Flash® Player.

In the case of image transformation, SWF files may contain encodings in DefineBitsLossless and DefineBitsLossless2 tags. Some browsers may only support JPEG, PNG or GIF images. The Cross-Compiler 1006 recodes images in the SWF file into image formats supported by browsers.

In the case of audio, SWF files may contain audio in several formats including uncompressed, ADPCM, MP3, Nellymoser and Speex. Most browsers support only MP3. The Cross-Compiler 1104 recodes audio in SWF files into formats supported by browsers, such as MP3.

Similarly, in the case of video, the content may be recoded into several different formats. A SWF file may contain video in h.263 or VP6 formats. The Cross-Compiler 1006 can recode the video into h.264, which is used by iOS, or WebM, which is used by Google Chrome, Firefox and Opera.

The Intermediate-code Runtime 1012 can determine which format of images, audio and video to load depending on the platform and browser being used on the portable device.

At step 1116, the intermediate representation is serialized to produce the Intermediate-Code Object, at step 1118. During serialization, each tag in the intermediate representation is outputted as a JSON object, including key:value pairs and arrays. All JSON objects are aggregated into a single JSON object representing all tags.

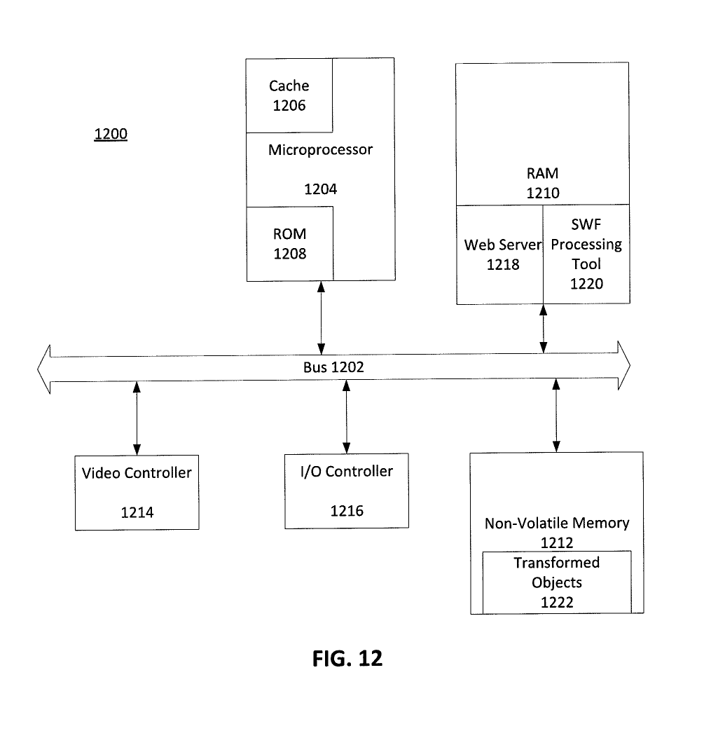

FIG. 1 shows a development environment 102. The development environment 102 can be a developer's personal computer/workstation, or could be a server computer that is accessed by a developer's personal computer as a client of the server computer. FIG. 12 is a block diagram for a server computer, in which the development environment is executed on the server computer.

As can be seen in FIG. 12 a server computer 1200 may include a microprocessor 1204 provided with a cache 1206, a read only memory (ROM) 1208, volatile memory (RAM) 1210, and one or more large storage devices (Non-volatile memory) 1212, with the memory devices communicating data over a bus 1202. The server computer 1200 may also include a display device 1214, and I/O devices 1218 that communicate with the microprocessor 1204 by way of display controller and I/O controller 1216 devices. The Cross-Compiler 1220 can perform conversion operations in RAM 1210 and generate Intermediate-Code Objects that are stored in a non-volatile memory 1212. Alternatively, an Intermediate-Code Object can be maintained in RAM 1210 for transmission by the Web Server 1218.

Developers that use a personal computer/workstation to develop graphic images and Movie Clips, for example, as creatives for advertisements, can obtain the cross-compiler by downloading the software and installing, or can obtain the software on a computer-readable storage medium. Examples of computer-readable storage media for distributing software include floppy disk, removable hard drive (HD), various optical storage media, such as compact disc read only memory (CD-ROM), digital versatile disc (DVD), as the most common, but can include other known computer-readable media such as magnetic tape, magneto-optical disc, secure digital (SD) chip, etc.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A computer-implemented method, wherein the computer includes at least one processing unit, a memory storing structured data, and a display device, comprising:
providing to the processing unit the structured data that defines a timeline for displaying an animation or scene, wherein the structured data includes at least one frame tag for one or more scenes, at least one control tag for placing display objects in the one or more scenes, and at least one display object tag that is under the control of the control tag;
the at least one processing unit performing steps of:
analyzing the structured data,
creating a set of interconnected nodes, comprising:
creating a root node that represents the timeline;
creating a frame node for the frame tag, and adding an edge that connects the frame node to the root node;
creating a control node for the control tag, and adding an edge that connects the control node to the frame node;
detecting a warning condition related to the display object tag;
creating a warning context node for the display object tag corresponding to the detected warning condition, and adding an edge that connects the warning context node to the control node, wherein the warning context node is not directly connected by an edge to the frame node;
selecting a representative path of edges connecting the warning context node associated with the display object tag to the root node,
generating a display for the representative path and a warning related to the warning condition; and
causing the representation of the path and the warning to be displayed by the display device.

2. The method of claim 1, wherein the structured data is a SWF file.

3. The method of claim 1, wherein the representative path is a shortest path of edges connecting the warning context node associated with the display object tag to the root node.

4. The method of claim 1, further comprising a step of selecting a path that includes names in control tags, and a step of displaying the selected path along with the warning.

5. A method performed by a computer having a memory and at least one processing unit, comprising:
providing in said memory at least one scene, control tags for manipulating the scene, and display object tags that are controlled by actions of the control tags;
creating by said at least one processing unit a set of interconnected nodes that have edges between a root node, at least one frame node for the at least one scene, control nodes for the control tags and display object nodes for the display object tags, wherein the display object nodes are not directly connected by an edge to the frame node, wherein the root node represents a timeline for displaying the scene;
detecting a warning condition related to one of the display object tags;
creating a warning context node for the one of the display object tags corresponding to the detected warning condition;
selecting a path among edges connecting the warning context node associated with the one of the display object tags to the root node;
generating a display for the selected path and a warning related to the warning condition; and
causing the warning related to the warning condition to be displayed based on the selected path.

6. The method of claim 5, further comprising a step of selecting by said processing unit a shortest path between the root node and the warning context node associated with the warning, and a step of displaying the shortest path together with the warning.

7. The method of claim 5, further comprising a step of selecting a path that includes names in control tags, and a step of displaying the selected path along with the warning.

8. A non-transitory computer-readable storage medium storing a program, which when executed by a computer, performs steps of:
providing the structured data that defines a timeline for displaying an animation or scene, the structured data includes a frame tag for one or more scenes, one or more control tags for placing display objects in the one or more scenes, and at least one display object tag that is under the control of the control tags;
analyzing the structured data,
creating a set of interconnected nodes, comprising:
creating a root node that represents the timeline;
creating a frame node for the frame tag, and adding an edge that connects the frame node to the root node;
creating a control node for each of the control tags, and adding an edge that connects the control node to the frame node;
detecting a warning condition related to the display object tag;
creating a warning context node for the display object tag corresponding to the detected warning condition, and adding an edge that connects the warning context node to the control node,
wherein the warning context node is not directly connected by an edge to the frame node;
selecting a representative path of edges connecting the warning context node associated with the display object tag to the root node;
generating a display for the representative path and a warning related to the warning condition; and
displaying by the display device the representation of the path and the warning.

9. A non-transitory computer-readable storage medium storing a program, which when executed by a computer, performs steps of:
providing at least one scene, control tags for manipulating the scene, and display object tags that are controlled by actions of the control tags;
creating a set of interconnected nodes that have edges between a root node, at least one frame node for the at least one scene, control nodes for control tags and display object nodes for display object tags, wherein the display object nodes are not directly connected by an edge to the frame node, wherein the root node represents a timeline for displaying the scene;
detecting a warning condition related to one of the display object tags;
creating a warning context node for the one of the display object tags corresponding to the detected warning condition;
selecting a path among edges connecting the warning context node associated with the one of the display object tag to the root node;
generating a display for the selected path and a warning related to the warning condition; and
displaying the warning based on the selected path.

10. A system, comprising:
a memory that is configured to store a SWF file that defines a timeline for displaying an animation or scene, the SWF file includes a frame tag for one or more scenes, one or more control tags for placing display objects in the one or more scenes, and at least one display object tag that is under the control of a control tag,
at least one processing unit that is configured to:
analyze the SWF file;
create a set of interconnected nodes, comprising:
creating a root node that represents the timeline,
creating a frame node for the frame tag, and adding an edge that connects the frame node to the root node,
creating a control node for each of the control tags, and adding an edge that connects the control node to the frame node,
detecting a warning condition related to the display object tag, and
creating a warning context node for the display object tag corresponding to the detected warning condition, and adding an edge that connects the warning context node to the control node, wherein the warning context node is not directly connected by an edge to a scene node;
select a representative path of edges connecting the warning context node associated with the display object tag to the root node; and
generate a display for the representative path and a warning related to the warning condition; and
a display device that displays the warning in conjunction with the representative path.

11. A system comprising:
a memory that is configured to store a SWF file that includes at least one scene, control tags for manipulating the scene, and display object tags that are controlled by actions of the control tags,
at least one processing unit that is configured to:
create a set of interconnected nodes that have edges between a root node, frame nodes for the at least one scene, control nodes for control tags and display object nodes for display object tags, wherein the display object nodes are not directly connected by an edge to the frame nodes, wherein the root node represents a timeline for displaying the scene;
detect a warning condition related to one of the display object tags;
create a warning context node for the one of the display object tags corresponding to the detected warning condition;
select a representative path of edges connecting the warning condition node associated with the one of the display object tags to the root node, and
generate a display for the representative path and a warning related to the warning condition; and
a display device that displays the warning in conjunction with the representative path.
